(19) United States
(12) Patent Application Publication
(10) Pub. No.: US 2013/0208369 A1
(43) Pub. Date: Aug. 15, 2013

(54) APPARATUS AND ACTUATOR FOR CONTROLLING THE INCLINATION OR ROTATION CENTER OF AN OPTICAL SYSTEM

(71) Applicant: Sio Kuan Lam, Hong Kong (HK)

(72) Inventor: Sio Kuan Lam, Hong Kong (HK)

(21) Appl. No.: 13/817,455

(22) PCT Filed: Aug. 19, 2011
(86) PCT No.: PCT/CN11/78613

§ 371 Date: Apr. 18, 2013

(30) Foreign Application Priority Data
Aug. 20, 2010 (CN) 201010258699.3

(51) Int. Cl. G02B 7/04

(52) U.S. Cl. CPC G02B 7/04
USPC 359/824; 359/823

(57) ABSTRACT

An apparatus for controlling optical-system inclination/rotation center, comprising a housing (200); a bracket (201) installed in the housing (200) for loading lenses; and a first spring system (202) and a second spring system (203) connected onto the housing (200) and the bracket (201), wherein either one of the spring systems is a planar spring system and comprised of at least one leaf spring, the surface of each leaf spring being generally parallel to the plane of the spring system; the planes of the first spring system (202) and the second spring system (203) being generally parallel with each other, and the normal direction of each spring system being generally parallel to the center axis of the bracket (201) or the lens optical axis; the effective elastic coefficient of said first spring system (202) in the lens axis direction is far less than that in the direction perpendicular to the lens axis; the effective elastic coefficient of the second spring system (203) in each direction is far less than that of the first spring system in the same direction.

### FIELD OF THE INVENTION

The present invention relates to an apparatus for controlling an inclination/rotation center of an optical axis in an optical system. More particularly, this invention relates to an actuator for controlling a position of the inclination/rotation center of a camera lens's optical axis and for generating motion that causes inclination/rotation of the optical system.

### BACKGROUND

The photo-taking function of a mobile phone is getting more and more matured. At present, a phone camera has already equipped with an auto-focusing function. How to provide the mobile-phone camera with an anti-shake function is a problem that requires solutions as soon as possible. Optical anti-shaking is a very simple physical principle, which uses lateral translation of an optical lens relative to an image sensor or provides inclination motion/rotation around the lens's optical axis to achieve the anti-shake function. Although traditional cameras have usually equipped with the optical anti-shake function, and despite related technologies and devices have already been mature and have also appeared in the market, the optical anti-shake technology used for mobile phone cameras is not mature. The main reason is that space limitation inside a mobile phone makes it extremely difficult to effectively realize the optical anti-shaking effect. U.S. Pat. No. Pat. No. 7,725,014 and CNJ01384954A have disclosed, and their technical focus is, how to enable an actuator to simultaneously produce linear motion and inclination motion (also referred to as rotation) such that these two motions can achieve the auto-focusing and the optical anti-shake functions. The technical focus of US2010/0080545A1 is about how to use a spring in an actuator as an electrode for providing electric power to the actuator. Although the technologies disclosed in the above-mentioned publications solve some problems that are respectively focused on, there are a lot of other problems. Amongst them, U.S. Pat. No. 7,725,014 describes the use of inclination motion to achieve the anti-shake function, in which the position of the inclination center (or the inclination reference point, also referred to as a rotational center or a rotation axis) is a very important parameter. This positional information significantly affects control parameters in realizing the anti-shake function, and hence the resultant anti-shake effect. Therefore, the anti-shake control can be made precise only if the position is known. However, the technologies in the above-mentioned disclosures do not propose any method to control the position of a tilt center (or a tilt reference point, or referred to as a rotational center or a rotational axis) during axis inclination. Therefore, it is by no means that the center position of inclination (or referred to as rotation) is known. It leads to increased difficulty in employing inclination (viz., rotation) to achieve the anti-shake function, thus requiring very sophisticated software to calculate the instantaneous inclination (viz., rotation); but the anti-shake effect is relatively poor. In addition, since the center position cannot be controlled, the torque required to control the lens rotation is often large, leading to a need for greater electrical power. Sometimes the required power is so great that it cannot be provided (under the mobile application environment), thus leading to a situation that the actuator cannot move.

### SUMMARY OF THE INVENTION

The technical problem solved by the present invention is that, targeting to inability of existing techniques in controlling the position of the lens rotation center, there is provided an apparatus for controlling the position of an inclination/rotation center of an optical axis in an optical system.

An object of the present invention is to provide an apparatus for controlling the position of an optical-system inclination/rotation center. Another object of the present invention is to provide an actuator for controlling the position of the optical-system inclination/rotation center, and enable the optical system to generate inclination/rotational motion.

In order to achieve the above-mentioned objectives, the present invention provides an apparatus (see FIG. 2) for controlling the position of an optical-system inclination/rotation center, comprising: a housing; a holder installed in the housing for loading a lens; and a first spring system and a second spring system both connected onto the housing and the lens holder; wherein: any of the spring systems is a planar spring system and comprises at least one leaf spring, the surface of each leaf spring being substantially parallel to the plane of said planar spring system; the planes of the first spring system and of the second spring system are generally parallel to each other, and the normal direction of each spring system is generally parallel to the center axis of the lens holder or the lens optical axis; the effective elastic coefficient of said first spring system in the lens axis direction is substantially less than that in the direction perpendicular to the lens axis; and the effective elastic coefficient of the second spring system in each direction is substantially less than that of the first spring system in the same direction.

In the apparatus for controlling the position of an optical-system inclination/rotation center as set forth in the present invention, a holder connecting arm refers to the part for connecting the spring system or the constituting spring to the lens holder as shown in FIG. 1a. The holder connecting arm is not deformable, and does not give rise to elastic force. The holder connecting arm is only for connecting the lens holder to the spring system or the constituting spring. A housing connecting arm (or called a fixed arm) refers to the part used for connecting the spring system or the constituting spring to the housing and/or the attachment fixed on the housing as shown in FIG. 1a. Similar to the holder connecting arm, the fixed arm is not deformable, and does not give rise to elastic force. A spring arm refers to the part connecting the holder connecting arm to the fixed arm as shown in FIG. 1a. It is the position to have shape deformation for generating elastic force.

The effective elastic coefficient of the spring system is defined as follows. FIG. 1a shows a planar spring system formed by four constituting springs. A coordinate system is defined, with reference to the figure and under the condition that the spring system is not deformed, by using the geometrical center or the center of the connecting ring as the origin of the coordinate system, where the connecting ring is formed by the holder connecting arms. Generally, the lens holder has a round hole for the lens to pass through and to be fixed thereon. Therefore, the holder connecting arms in the spring system generally follow the centre of this round hole for being symmetrically disturbed. (Note that the symmetry described herein is for the purpose of convenience, and is not an essential feature in the present invention). The XY plane and the spring plane coincide, and the Z-axis is in the direction perpendicular to the spring plane. In the apparatus disclosed in the present invention, all holder connecting arms in the spring system connect to the lens holder. As the lens holder is rigid, all the holder connecting arms move or shift coherently. The housing connecting arm in the spring system can connect to the housing or on the attachment fixed on the housing so that all the housing connecting arms in the spring system are fixed to be immobile. When there is force acting on the lens holder, the lens holder moves along the direction of the force to thereby generate the same displacement of all the housing connecting arms in the spring system as the lens holder, thus making the spring arms of all constituting springs produce equivalent deformation to generate elastic force. Under a condition of static equilibrium, the resultant force f and the acting force F of the elastic force generated by all the spring arms are equal in magnitude but opposite in direction. In this condition, we can make use of Hooke's law to define the effective elastic coefficient. As shown in FIG. 1b, when the acting force is along the normal z-direction of the plane of the spring system, the lens holder under the force drives all the holder connecting arms in the spring system to move with a distance Z along the z direction. By using Hooke's law, we get

F_{z}=−f_{z}=−k_{z}

where k_{z} is defined as the effective elastic coefficient along the Z-direction in the spring system. Similarly, as shown in FIG. 1c, when the acting force is applied along any direction on the plane of the spring system, the displacement of the holder connecting arm along that direction can be decomposed into displacements in the X and the Y directions. According to the principle of force decomposition, the acting force can also be decomposed into component forces in the X and the Y directions. The component forces are obtained by Hooke's law as

F=−fₓ=−kₓ (in the X direction)

F_{y}=−f_{y}=−k_{y} (in the Y direction)

where kₓ and k are defined as the effective elastic coefficients along the X and the Y directions, respectively, in the spring system, and fₓ and f_{y} are the components of the elastic resultant forces in the X and the Y directions, respectively.

In the apparatus for controlling the position of an optical-system inclination/rotation center according to the present invention, for the holder connecting arm of each leaf spring in the first spring system, those sections connecting to the lens holder can be situated on the same plane perpendicular to the lens axis, or be different from this plane. For the second spring system, the above same characteristic conditions are also established. It is as shown in FIG. 4. In the apparatus for controlling the position of tilt/rotation centre in an optical system according to the present invention, for each leaf spring in the first spring system, those sections connecting to the housing, can be situated either on the same plane perpendicular to the optical axis of the lens, or different from this plane. For the second spring system, the above same characteristic conditions are also established as shown in FIG. 4.

In the apparatus for controlling the position of an optical-system inclination/rotation center according to the present invention, the spring system can be made from various materials having a certain degree of elasticity, such as a plastic sheet, a metal sheet, a thin-film or a thick-film material, a ceramics sheet or the like, or a composite material comprising a variety of materials with certain degrees of elasticity such as a flexible printed circuit board. See FIG. 5.

In the apparatus for controlling the position of an optical-system inclination/rotation center according to the present invention, the first spring system can comprise more than one planar spring system, and all constituting planar spring systems are substantially parallel to each other, and substantially perpendicular to the lens-axis direction. Under this condition, the combined effect of all the constituting planar spring systems can be equivalent to a virtual planar spring system, and its plane position is on the plane position of the first spring system, while not being a real physical plane. The same characteristics can be applied to the second spring system. See FIG. 6.

In the apparatus for controlling an optical-system inclination/rotation center according to the present invention, the second spring system can be based on another form of the spring rather than the leaf spring, and the effective elastic coefficient of the second spring system in each direction can be substantially less than the effective elastic coefficient of the first spring system in the corresponding direction. See FIG. 7.

Another objective of the present invention is to provide an actuator for controlling the position of an optical-system inclination/rotation center and enabling the optical system to produce inclination/rotation. The actuator (see FIG. 8) includes: a housing; a holder disposed in the housing for loading a lens; a plurality of actuating members disposed around the lens holder and coupled thereto, wherein at least one actuating member includes at least one magnet, at least one coil, and at least one actuating member includes at least one yoke; and a first spring system and a second spring system connected onto the housing and the lens holder, wherein (1) either one of the spring systems is a planar spring system and comprises at least one leaf spring, the surface of each leaf spring being substantially parallel to the plane of the planar spring system, (2) the planes of the first spring system and the second spring system are generally parallel to each other, and the normal direction of each spring system are generally parallel to the center axis of the lens holder or the lens optical axis, (3) the effective elastic coefficient of said first spring system in the lens-axis direction is substantially less than that in the direction perpendicular to the lens axis, and (4) the effective elastic coefficient of the second spring system in each direction is substantially less than that of the first spring system in the same direction.

In the actuator for controlling the position of an optical-system inclination/rotation center and enabling an optical system to generate inclination/rotation according to the present invention, the yoke can comprise one or more magnets. The actuator comprises at least one actuating member installed independently with at least one yoke, or shares with at least one other actuating member with at least one yoke. The actuating member can be independently controlled to generate independent motion. If, during the control process of each actuating member, each actuating member is precisely controlled to coordinate its independent motion such that all actuating members are moved in a relatively coherent manner, then the linear motion of the lens holder can be realized. If the direction of linear motion is along the direction of the lens holder's axis, the linear motion can be used to adjust the relative distance between the lens and an image sensor in order to achieve the focusing function. If the independent motion of each actuating member is not coherent with each others, the lens holder can be caused to rotate or incline. This rotation or inclination motion can be used for the image stabilization function or for the vibration compensation function of a photographic system. Furthermore, the actuating member can be independently and precisely controlled so as to enable all the actuating members to realize coherent or incoherent independent motion. Switching between the two modes of motion can be used to realize an independent linear motion, an independent rotation or swinging of the lens holder, or a compound motion involving the two kinds of motion, so as to realize an independent auto-focusing function or an independent vibration-compensation function, or to realize these two functions simultaneously.

In the actuator for controlling the position of an optical-system inclination/rotation centre and enabling an optical system to generate inclination/rotation according to the present invention, for the holder connecting arm of each leaf spring in the first spring system, those sections connecting to the lens holder can be situated on the same plane perpendicular to the optical axis of the lens, or on different planes. For the second spring system, the same characteristics as mentioned above are also employed, as is shown in FIG. 4. In the apparatus for controlling the position of the optical-system inclination/rotation centre according to the present invention, for each leaf spring in the first spring system, those sections connecting to the housing can be situated either on the same plane perpendicular to the optical axis of the lens, or on different planes. For the second spring system, the same characteristics as mentioned above are also employed as is shown in FIG. 4.

In the actuator for controlling the position of an optical-system inclination/rotation center and enabling the optical system to generate inclination/rotation according to the present invention, the spring system can be made from various materials having a certain degree of elasticity, such as a plastic sheet, a metal sheet, a thin-film or a thick-film material, a ceramics sheet or the like, or a composite material comprising a variety of materials with certain degrees of elasticity such as a flexible printed circuit board and the like. See FIG. 5. Furthermore, if the elastic material is metal or a conductive material or another conductive composite material, the spring system can also be used as an electrode or an electrical connection component to conduct electric current or voltage to a coil or to the actuator.

In the actuator for controlling the position of an optical-system inclination/rotation centre and enabling the optical system to generate inclination/rotation according to the present invention, the first spring system can comprise more than one planar spring system, and all constituting planar spring systems are substantially parallel to each other, and substantially perpendicular to the direction of the lens axis. Under this condition, the combined effect of all the constituting planar spring systems can be equivalent to a virtual planar spring system, and its plane position is above the plane position of the first spring system, while not being a real physical plane. The same characteristics can be applied to the second spring system. See FIG. 6.

In the actuator for controlling the position of an optical-system inclination/rotation center and enabling the optical system to generate inclination/rotation according to the present invention, the second spring system can be based on another spring system format rather than the leaf spring, and the effective elastic coefficient of the second spring system in each direction is substantially less than the effective elastic coefficient of the first spring system in the corresponding direction. See FIG. 7.

In the actuator for controlling the position of an optical-system inclination/rotation center according to the present invention, at least one of the actuating members can be a piezoelectric actuator or an energy convertor.

### BRIEF DESCRIPTION OF THE DRAWINGS

Embodiments of the present invention are further illustrated in conjunction with the drawings, in which:

FIG. 1 is a schematic diagram illustrating a definition of an effective elastic coefficient in a spring system according to the present invention (the XY axes shown in the subplot a divide a spring into four identical parts as ABCD, having four identical connecting arms, spring arms, housing connecting arms, and the subplot a uses the geometrical center or the center of circle of the connecting ring formed by the holder connecting arms as a coordinate origin; the subplot d uses the geometrical center or the center of the circle of the connecting ring formed by the holder connecting arms as a coordinate origin);

FIG. 2 is a schematic diagram of a structure of an apparatus for controlling the position of an optical-system inclination/rotation center according to the present invention;

FIG. 3 depicts a rotation center of the lens holder;

FIG. 4 is a schematic diagram illustrating a connection between holder connecting arms and housing connecting arms (in subplot a, the holder connecting arm of the spring is connected to the same end face of the Holder at a position shown by the arrow; in subplot a, there are four such connections, but in actual implementations it may be greater than or less than four connections; in subplot b, the holder connecting arm of the spring is connected to a non-end face of the Holder at an arbitrary position, where in this example a side of the Holder is a cylindrical surface; in subplot d, there are four such connections, but in actual implementations it may be greater than or less than four connections);

FIG. 5 depicts a schematic diagram showing the structure of materials of a spring system (the material in subplot a is plastic; the material in subplot b is ceramic; the material in subplot c is metal);

FIG. 6 depicts a schematic diagram of a compound spring system;

FIG. 7 depicts possible embodiments that uses spring systems other than the leaf spring system; and

FIG. 8 depicts a schematic diagram of an actuator for controlling the position of an optical-system inclination/rotation center according to the present invention (subplot c shows a schematic diagram of an actuator for controlling the position of an optical-system inclination/rotation center and enabling the optical system to generate inclination/rotation according to the present invention).

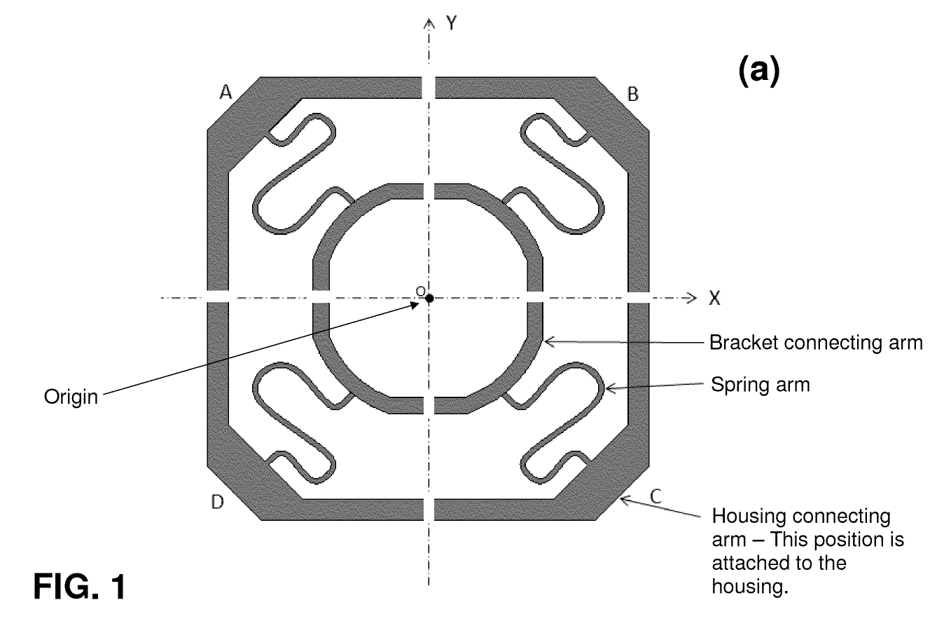

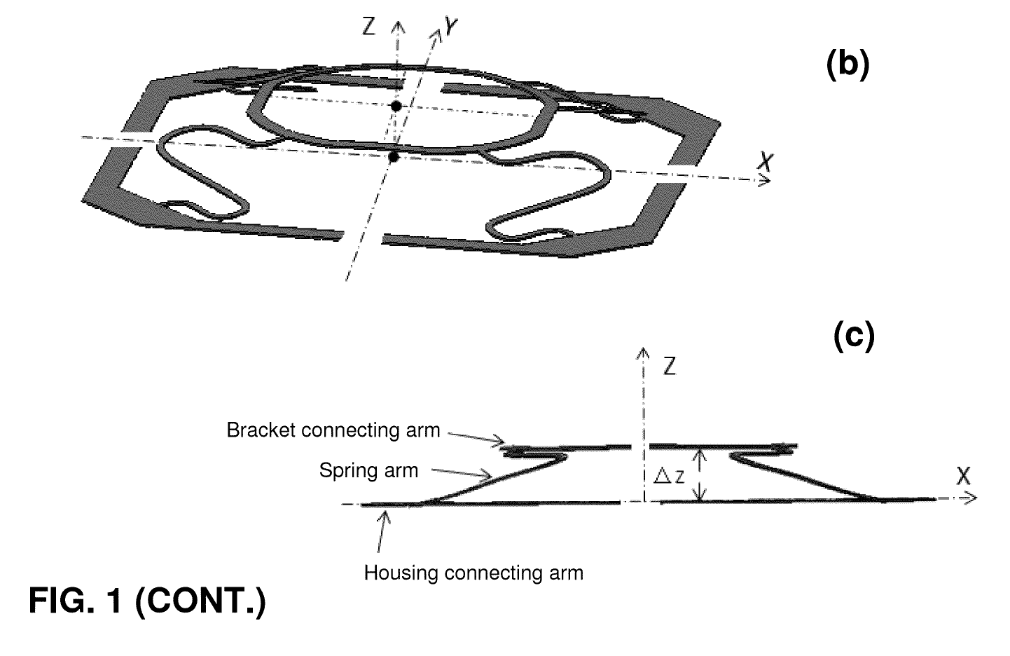

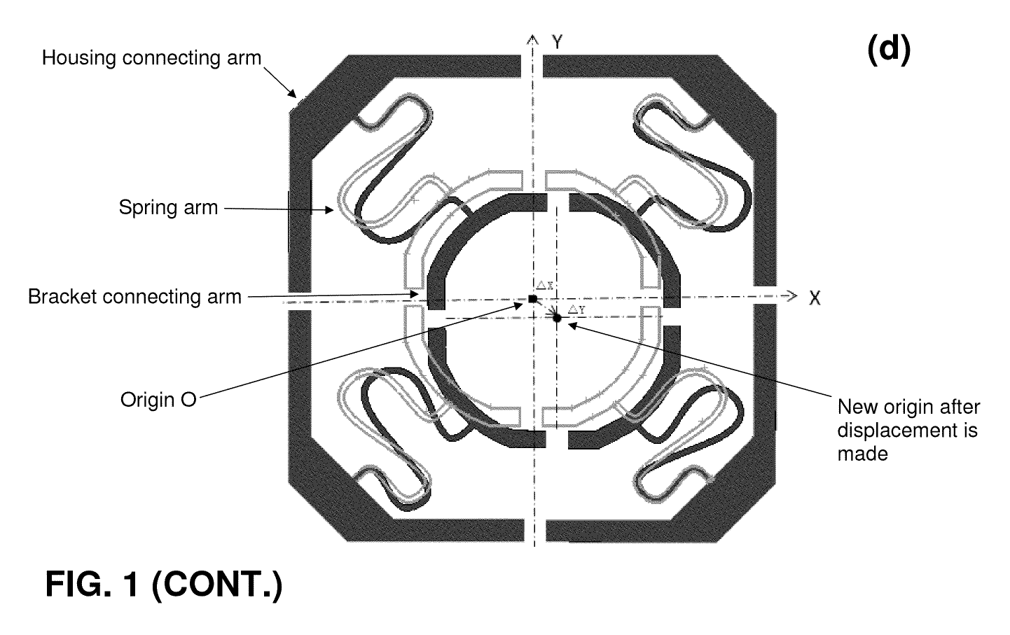

### DETAILED DESCRIPTION

In order to have a clearer understanding of the purpose, the technical features and effects of the present invention, specific embodiments of the present invention are described hereinafter in detail with reference to the drawings.

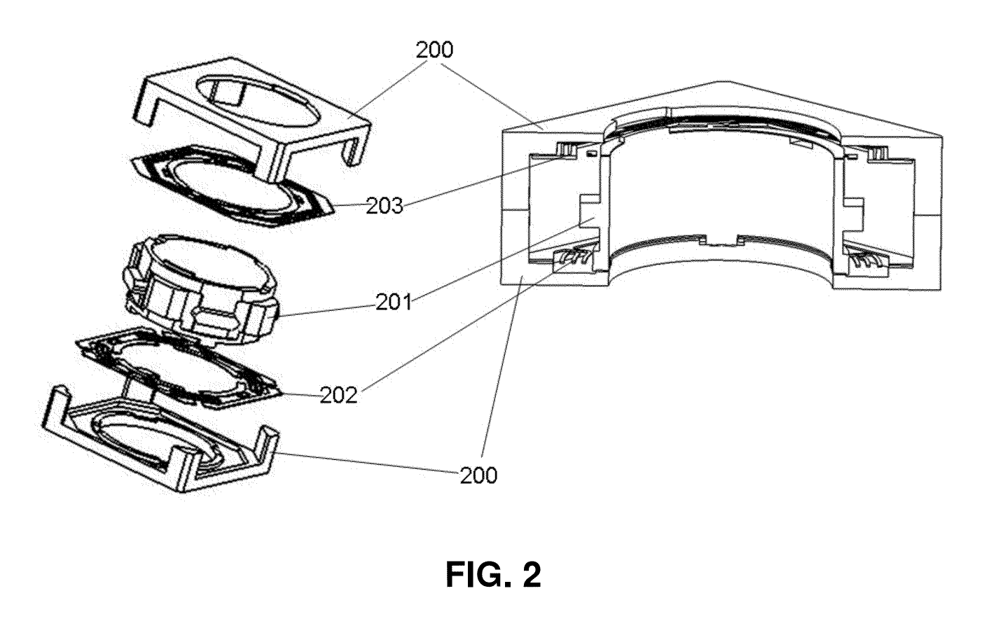

FIG. 2 depicts a schematic diagram of an apparatus for controlling the position of an optical-system inclination/rotation center according to one embodiment of the present invention. The apparatus for controlling the position of the optical-system inclination/rotation center according to the present invention includes: a housing 200; a lens holder 201, disposed in the housing 200, for loading a lens, where in certain embodiments, the lens holder 201 can partially extend outside the housing; a first spring system 202 and a second spring system 203, wherein the two spring systems are fixed on the lens holder 201 and the housing 200.

Since an effective elastic coefficient of a spring system (either the first or the second spring system) along the axis direction of the lens holder (or the optical-axis direction) in the apparatus of the present invention is substantially smaller than effective elastic coefficients along directions perpendicular to a plane that embodies the axis (or the effective elastic coefficients on the X and the Y directions). Therefore, when there is a force applied on the lens holder, it is easy for the lens holder to generate displacement along the axis direction (i.e. along the Z-direction) while it is difficult to generate displacement along any direction on a plane perpendicular to the axis (or, say, along the X and the Y directions). In other words, a displacement of the lens holder along the axis direction is substantially greater than a displacement along any of the X and the Y directions.

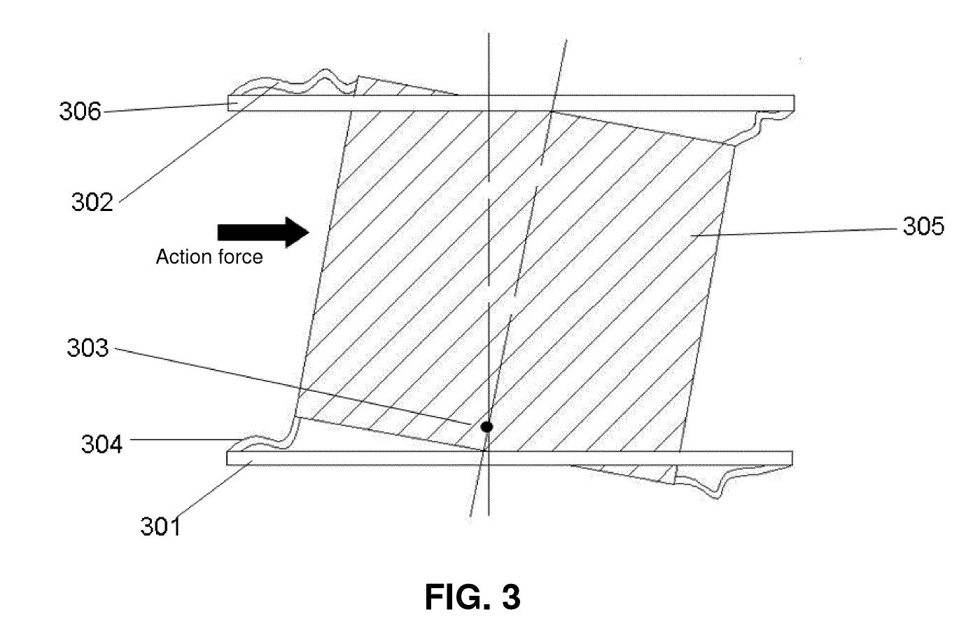

Furthermore, in the apparatus of the present invention, an effective elastic coefficient of the second spring system along any direction is substantially less than an effective elastic coefficient of the first spring system in the corresponding direction so that displacements generated by the lens holder at an end of the second spring system in the X and the Y directions are substantially greater than displacements generated by the lens holder at an end of the first spring system in the X and the Y directions, respectively. The combined result of the two motions enables the lens holder to produce inclination, which is also called rotation. In FIG. 3, the reference numerals 301 and 306 denote the first spring system and the second spring system, respectively; the numerals 302 and 304 denote spring arms; the numeral 303 denotes the inclination/rotation center of the lens holder; and the numeral 305 denotes the lens holder. If the effective elastic coefficients of the first spring system in the X and the Y directions are designed to be very large while the effective elastic coefficients of the second spring system in the corresponding directions are very small, the net effect of combining the motions is like an end of the first spring system being fixed immobile while an end of the second spring system is rotated around the end of the first spring system. The overall result is that the lens holder is inclined or rotated around a centre 303 and the position of the centre is around the first spring system. When the effective elastic coefficient of the first spring system is substantially greater than the effective elastic coefficient of the second spring system, the inclination/rotation center is basically on the spring plane of the first spring system. Conversely, if the effective elastic coefficient of the second spring system is greater than the effective elastic coefficient of the first spring system, the inclination/rotation center will move towards the second spring system. Therefore, through careful adjustment of the proportion between the effective elastic coefficients of the two spring systems, we can design the position of the inclination/rotation centre of the lens holder according to needs.

The aforementioned disclosure only provides a qualitative description of the function and the principle of the apparatus as disclosed in the present invention. Based on equations in mechanics, and after the torque effect generated by an action force is taken into account, detailed simulation also yields an overview picture the same as the one provided in the aforementioned disclosure regarding the physical behavior of the inclination/rotation of the lens holder.

In the apparatus for controlling the position of an optical-system inclination/rotation center according to the present invention, since the effective elastic coefficient along the axis direction of the lens holder (i.e. along the Z direction) of any of the first and the second spring system is substantially smaller than the effective elastic coefficient thereon in a vertical direction (i.e. along the X or the Y direction), the lens holder can be displaced along the Z direction with only a small amount of force. Such displacement is especially important because we can use this displacement to adjust the relative distance between an optical lens and an image sensor in order to achieve a focusing function (either manual focusing or auto focusing). In addition, since the position of the inclination/rotation center of the lens holder becomes designable, we can predict this position, such that the motion of the inclination/rotation of the lens holder is made simple and becomes predictable. This result is very important in using the lens inclination/rotational motion to realize an anti-shake function of the lens. Since the predictability of the lens inclination/rotation reduces the difficulty in controlling the same, the reliability is increased while complexity of the program for computing the position of the instantaneous inclination (or the rotation) center is reduced, thereby increasing the speed of control and enhancing the control accuracy. Furthermore, based on computation results, it is shown that if the first and the second spring systems are substantially similar, the energy required to generate inclination/rotation will be significantly greater than the energy required by the apparatus of the present invention to generate the same tilt/rotation.

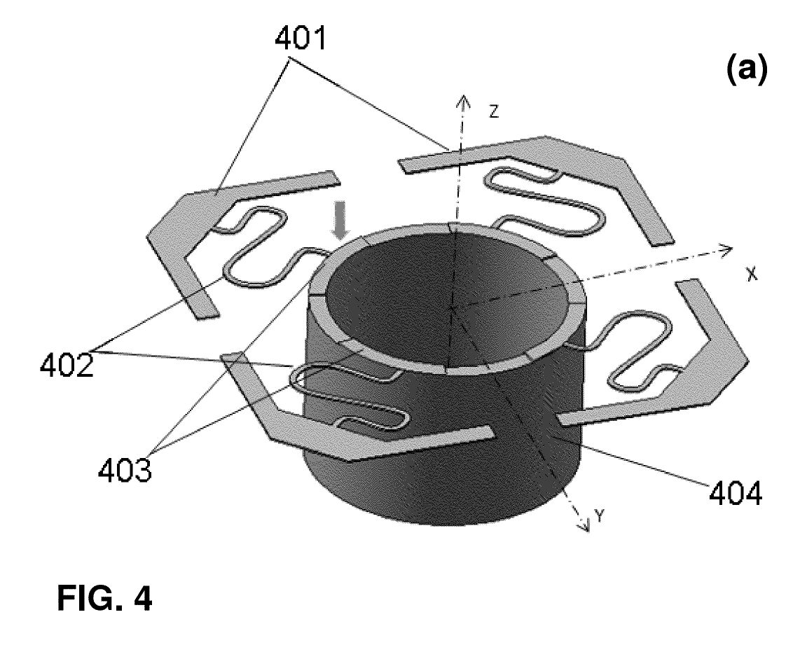

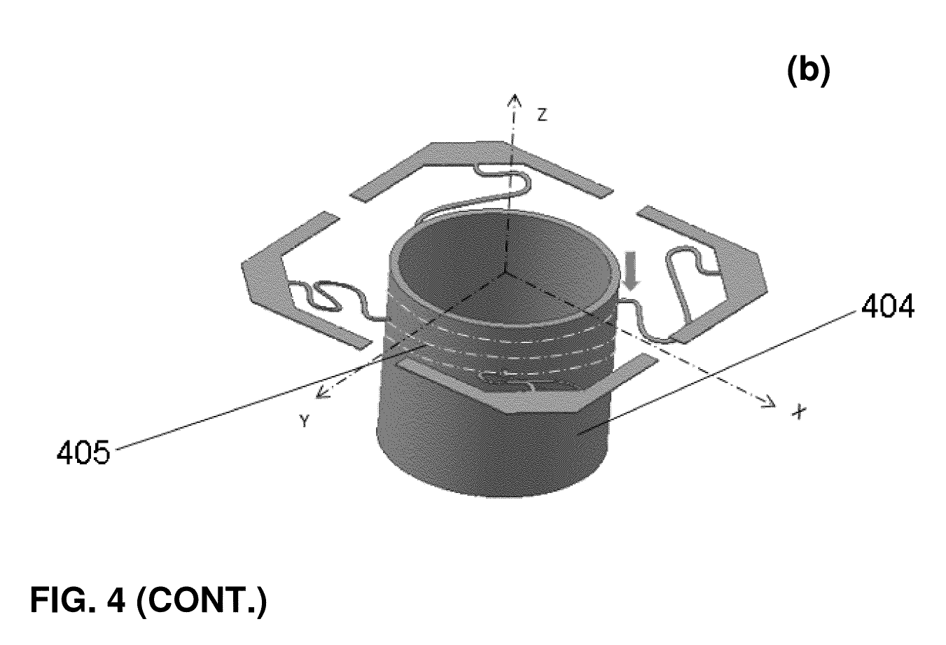

FIG. 4 depicts an embodiment of a method for connecting a connecting arm of the spring system as set forth in the present invention and a housing connecting arm. As shown in FIG. 4a, four independent leaf springs form a spring system, where the reference numeral 401 indicates a housing connecting arm, the numeral 402 indicates a spring arm, the numeral 403 indicates a holder connecting arm, and the numeral 404 indicates a lens holder. As shown in FIG. 4a, the holder connecting arm 403 and the lens holder 404 are connected on the same plane. In the present embodiment, this plane is one of end surfaces of the lens holder. In a practical application, this plane is not necessary to be on an end surface of the lens holder. FIG. 4b depicts another embodiment, where the holder connecting arm 403 is not connected to an end surface of the lens holder but is connected to a part of the lens holder. Dotted lines 405 form a surface for the holder connecting arm 403 to connect to the lens holder. As shown in FIG. 4, surfaces each of which is formed when the holder connecting arm 403 of a leaf spring is connected to the lens holder do not lie on the same plane. As long as these surfaces (being flat) are not far away from each others, the overall effect of the leaf springs can be replaced by a virtual planar spring. All of the aforementioned embodiments can be applied to the first and the second spring systems, and may be applied simultaneously or at different times.

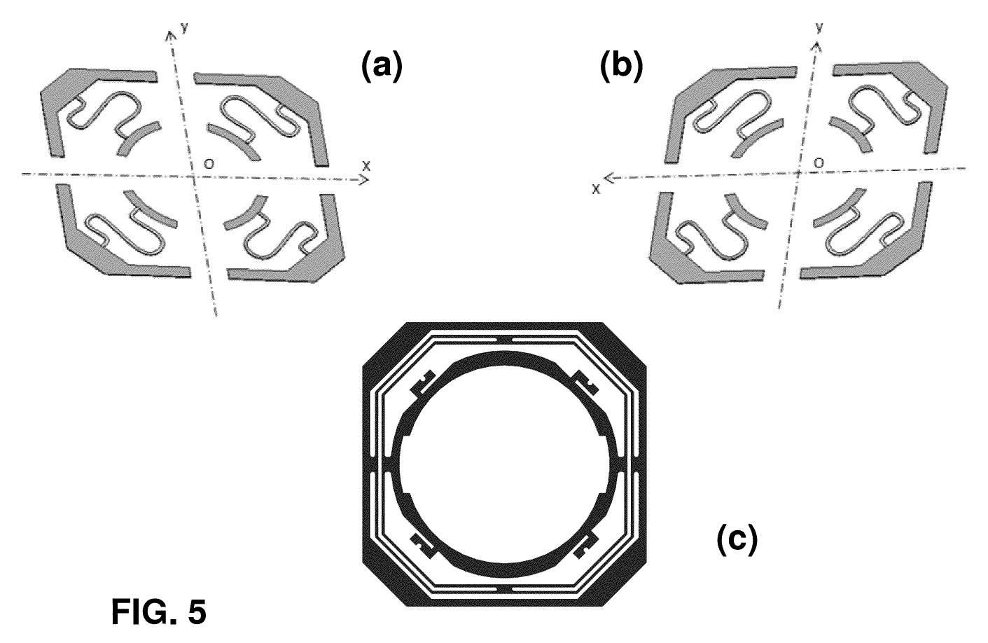

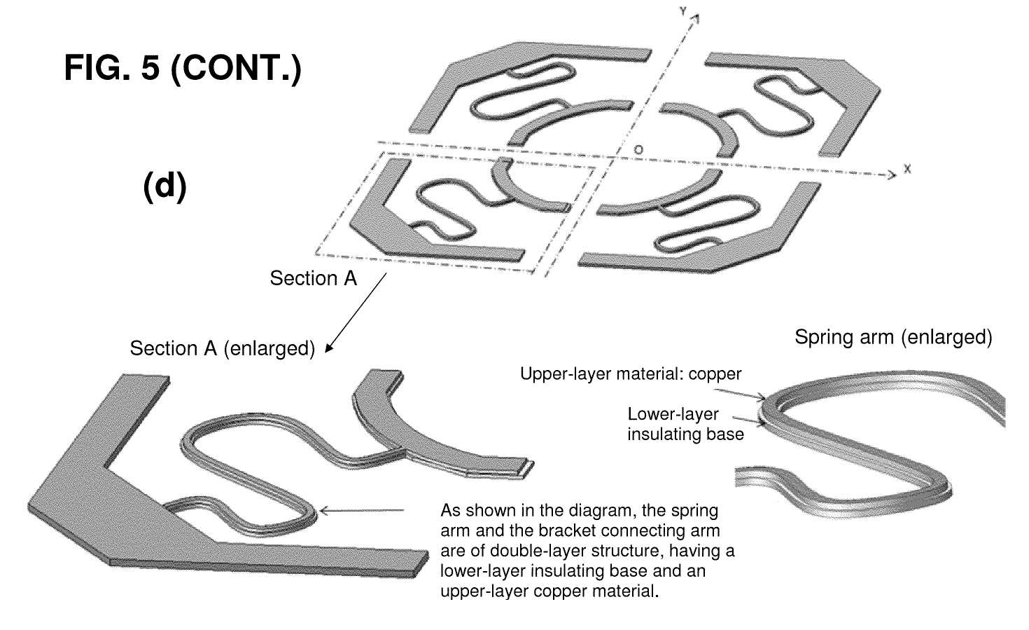

FIG. 5 depicts different materials of the spring in accordance with various embodiments. A material of the spring as set forth in the present invention can be selected from any material possessing elasticity for making this material into a planar form. As shown in FIGS. 5a, 5b and 5c, materials that can be selected include, but is not limited to, plastics, ceramics, metal, macro-molecular polymer, etc. In other words, any material, as long as the working range of the designed spring is in the material's elastic deformation region, can be used in the spring system of the present invention. In particular, some composite materials can also be used for making the spring system. FIG. 5d shows a composite material, where the corresponding mode of composing is by (but is not limited only to) coating a metal film on a layer of an insulated material so as to enable the upper layer to conduct electricity. If the spring system employs metal or a conductive material (including a composite material), the spring system can also be used as an electrode or an electrical-connection component for providing current or voltage to the actuator.

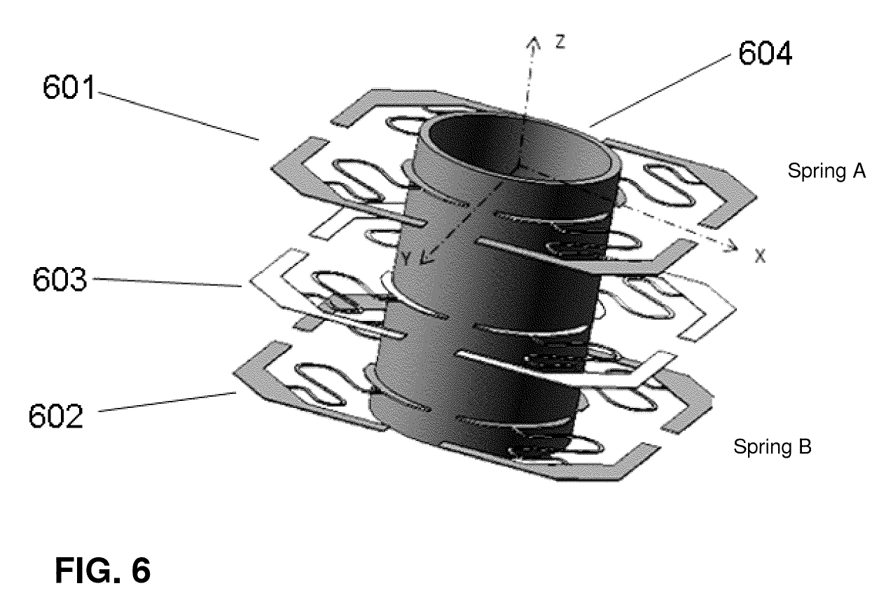

FIG. 6 shows an embodiment of a compound spring system. In the first and the second spring systems of the present invention, any one of these spring systems can comprise a plurality of constituting planar spring systems. As shown in FIG. 6, the reference numerals 601 and 602 indicate two physically-existed planar spring systems, and both are connected on a lens holder 604. Within the range of elastic deformation, the total effect of these spring systems can be mathematically shown to be equivalent to that of a planar spring 603 as seen in FIG. 6. It is possible to put the planar spring 603 in the 603 position, and its mechanical effect is the same as combining the spring systems 601 and 602. Therefore, among various other embodiments of the present invention, for an embodiment having more than two planar springs, the first and the second spring systems refer to such virtual planar spring 603, which is a conceptual spring in mathematics, not a physical spring.

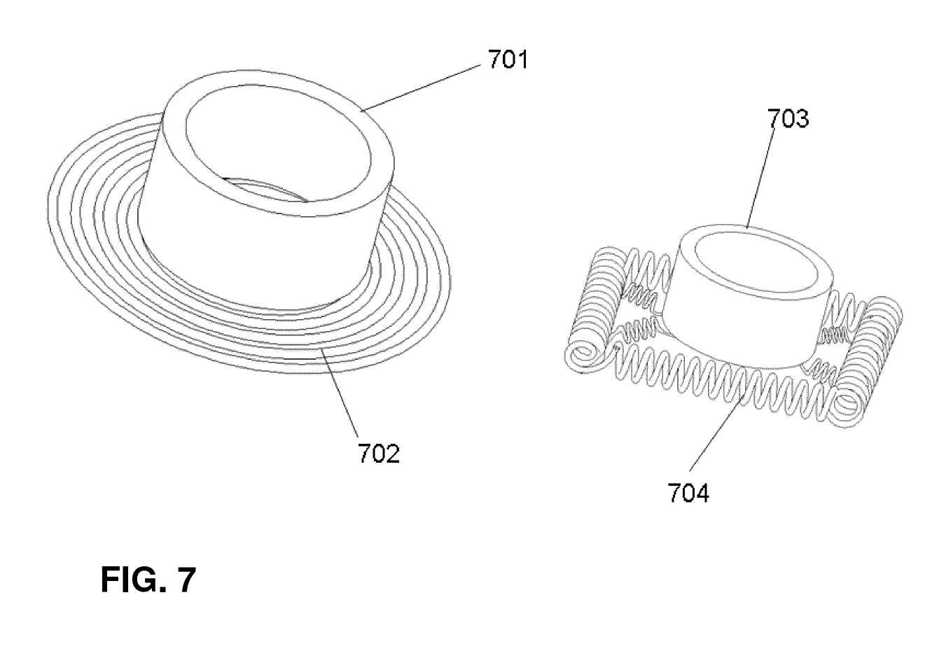

Apart from embodiments of the various aforementioned spring systems, FIG. 7 also depicts other embodiments of the second spring system according to the present invention. The reference numerals 701 and 703 refer to lens holders, the numeral 702 refers to an annular swirling spring and the numeral 704 refers to a cylindrically-shaped helical spring. As long as designs and materials are properly selected, these springs can achieve the desired function of the second spring system provided an effective elastic coefficient in a direction is substantially less than an effective elastic coefficient of the first spring system in the same direction.

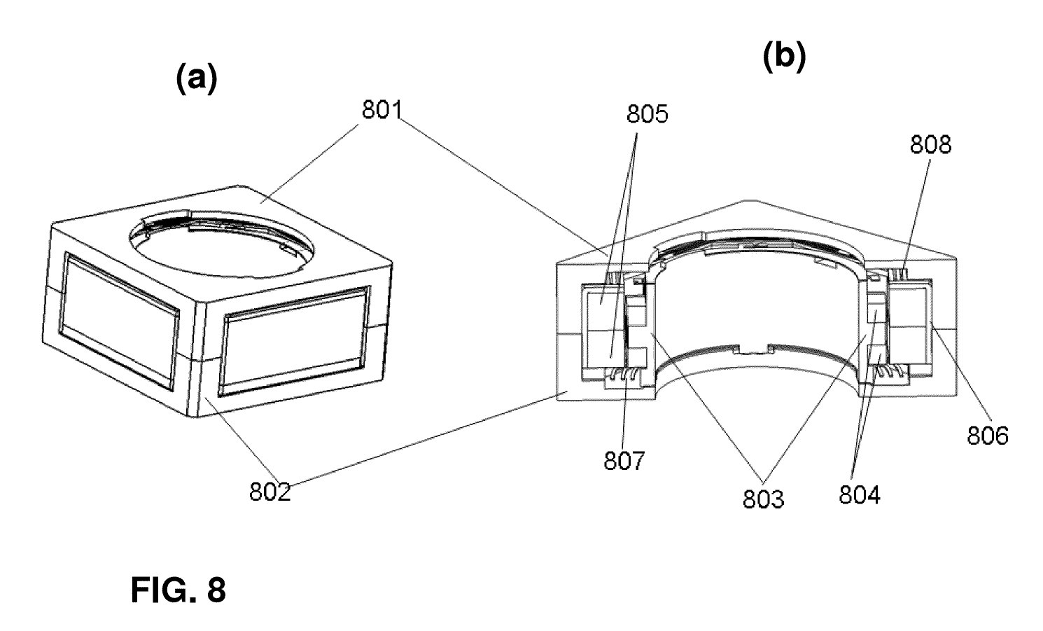

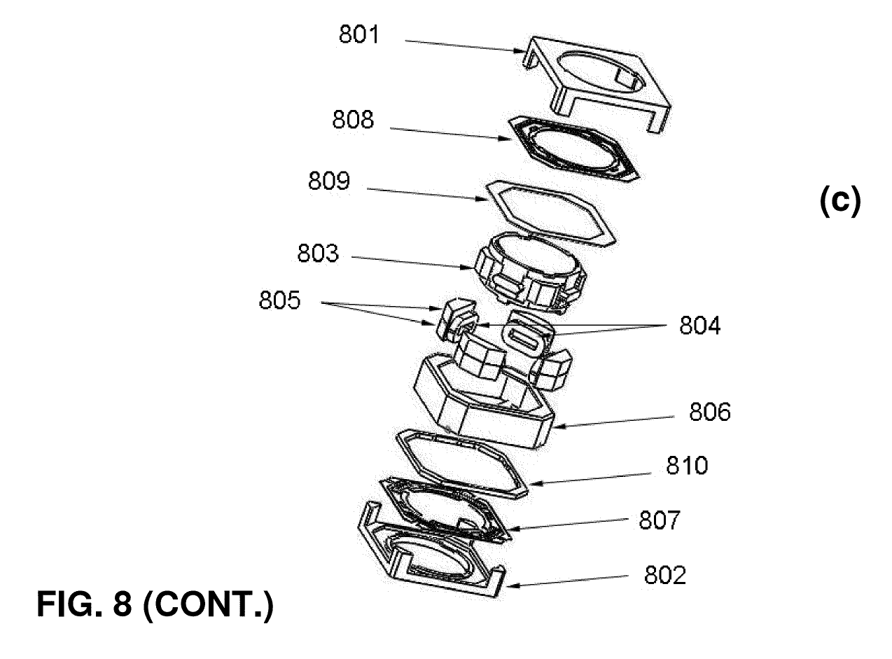

FIG. 8 shows an embodiment, in accordance with the present invention, of an actuator for controlling the position of an optical-system inclination/rotation center and enabling the optical system to generate inclination/rotation. Details of realizing this embodiment are as follows. FIG. 8a depicts an outlook of the actuator. FIG. 8b provides a cross-sectional view of the outlook along the diagonal direction. FIG. 8c gives a schematic diagram of the structural assembly. As seen from the figure, the aforesaid actuator includes housings 801, 802. A lens holder 803 is disposed within the housings. In some embodiments, the lens holder can partially extends out of the housings. The lens holder has a through hole (with or without thread) for mounting a lens or any other optical device. More-than-one actuating members are installed around the lens holder, and each actuating member comprises a coil 804, a magnet 805 and a yoke 806, wherein the coil 804 is fixed to the lens holder 803 while the magnet 805 is fixed in the yoke 806, the yoke is fixed on the housing 801 and/or the housing 802. The coil and the magnet are arranged face-to-face, and a force is generated along an axis of the lens holder (that is, the Z direction) when electricity is provided. The plurality of actuating members can be mounted either symmetrically around the lens holder, or not symmetrically around the lens holder. In both ends of the lens holder or a zone nearby the ends, the two spring systems 807, 808 are connected to the lens holder and the housings, wherein: the first spring system refers to a planar spring system and comprises at least one leaf spring, and the plane of each leaf spring is substantially parallel to the plane of the spring system; the plane of the spring system 807 and the plane of the spring system 808 are substantially parallel to each other, and a normal direction of each planar spring system is substantially parallel to the axis of the lens holder or the optical axis of lens; for the spring system 807, an effective elastic coefficient along the axis direction of a lens is much less than an effective elastic coefficient in the direction perpendicular to the axis direction of the lens; the effective elastic coefficients in any direction of the spring system 808 is much smaller than the effective elastic coefficient of the spring system 807 in the same direction. The reference numerals 809 and 810 indicate insulating pads.

In the present embodiment, since the actuating members are located around the lens holder and each actuating member can independently generate a force along the Z direction to produce motion for a part to which the lens holder and said each actuating member are coupled. Therefore, by meticulous control of the actuating members, motions produced independently by the actuating members can be turned into an overall, coordinated motion, so as to achieve a linear motion of the lens holder. If the direction of the linear motion is along the axis direction of the lens holder, the linear motion can be used to adjust the relative distance between a lens and an image sensor in order to achieve the focusing function. In addition, careful control of each actuating member can make the lens holder rotate or produce an inclination motion, and the rotation or the inclination motion can be used in an image stabilization function or a vibration compensation function of a photographic system.

In the present embodiment, various aforementioned embodiments about spring systems can be applied to the actuator for controlling the position of an optical-system inclination/rotation center and enabling the optical system to generate inclination/rotation as set forth in the present invention.

The embodiments of the present invention have been illustrated in the above in conjunction with the accompanying drawings. However, the present invention is not limited to the embodiments described above. The embodiments described above are merely illustrative and are not restrictive. Under the inspiration of the present invention, without departing the objectives of the present invention and within the protection scope of the appended claims, an ordinary technical person skilled in the art can develop many different forms. These different forms are within the scope of protection of the present invention.

1. An apparatus for controlling a position of an optical-system inclination/rotation center, comprising:
a housing; and
a holder for holding a lens, at least a part of the lens holder being installed in the housing; and
a first spring system and a second spring system both connected to the housing and the lens holder;
wherein:
any of the first spring system and the second spring system is a planar spring system comprising one or more leaf springs, a plane of any of the one or more leaf springs being substantially parallel to the planar spring system's plane;
the first spring system's plane and the second spring system's plane are substantially parallel to each other;
a normal direction of any of the first spring system and the second spring system is substantially parallel to a center axis of the lens holder or an axis of lens optics;
an effective elastic coefficient of the first spring system in a direction of the lens axis is substantially less than an effective elastic coefficient of the first spring system in a direction perpendicular to the direction of the lens axis; and
an effective elastic coefficient of the second spring system in any direction is substantially less than an effective elastic coefficient of the first spring system in the same direction.

2. The apparatus of claim 1, wherein connection section(s), the area where the spring makes physical contact with the lens holder, of any of the one or more leaf springs of the first spring system (and/or the second spring system) reside either on a plane perpendicular to the lens axis or on different planes.

3. The apparatus of claim 1, wherein connection section(s), the area where the spring makes physical contact with the housing, of any of the one or more leaf springs of the first spring system (and/or the second spring system) reside either on a plane perpendicular to the lens axis or on different planes.

4. The apparatus of claim 1, wherein any of the first spring system and the second spring system is made of a plastic sheet, a metal sheet, a thin-film material, a thick-film material, a ceramic sheet, a polymer material, or a composite material comprising a plurality of elastic materials or flexible printed circuit board.

5. The apparatus of claim 1, wherein the first spring system or the second spring system further comprises one or more additional planar spring systems, whereby the planar spring system and the one or more additional planar spring systems altogether are regarded as constituting planar spring systems.

6. The apparatus of claim 5, wherein all the constituting planar spring systems are substantially parallel to each others and substantially perpendicular to the direction of the lens axis.

7. (canceled)

8. The apparatus of claim 1, wherein the second spring system is formed by one or more springs other than the one or more leaf springs.

9. An actuator for controlling an optical-system inclination/rotation center, comprising:
a housing;
a holder for holding a lens, at least a part of the lens holder being installed in the housing;
a plurality of actuating members disposed around the lens holder and coupled thereto, wherein at least one of the actuating members comprises at least one magnet, at least one coil, and wherein at least one of the actuating members comprises at least one yoke; and
a first spring system and a second spring system both connected to the housing and the lens holder, wherein:
any of the first spring system and the second spring system is a planar spring system comprising one or more leaf springs;
a plane of any of the one or more leaf springs is substantially parallel to the planar spring system's plane;
the first spring system's plane and the second spring system's plane are substantially parallel to each other;
a normal direction of any of the first spring system and the second spring system is substantially parallel to a center axis of the lens holder or an axis of lens optics;
an effective elastic coefficient of the first spring system in a direction of the lens axis is substantially less than an effective elastic coefficient of the first spring system in a direction perpendicular to the direction of the lens axis; and
an effective elastic coefficient of the second spring system in any direction is substantially less than an effective elastic coefficient of the first spring system in the same direction.

10. The actuator of claim 9, wherein the actuating members are independently controlled to generate independent motions in order to enable the lens holder to realize inclination/rotation or to swing.

11. The actuator according to claim 9, wherein the actuating members are coordinated and controlled to enable each of the actuating members to independently perform substantially similar motion in order to drive the lens holder to perform linear motion.

12. The actuator according to claim 9, wherein the actuating members are precisely controlled to enable the actuating members to realize coherent or incoherent, independent motion, such that switching between the coherent motion and the incoherent motion allows realizing an independent linear motion, an independent rotation or swinging of the lens holder, or a compound motion involving the coherent motion and the incoherent motion.

13. The actuator according to claim 9, wherein at least one of the actuating members is equipped with at least one yoke, or is together with at least one of other actuating members to possess at least one yoke.

14. (canceled)

15. The actuator according to claim 9, wherein connection section(s), the area where the spring makes physical contact with the lens holder, of any of the one or more leaf springs of the first spring system (and/or the second spring system) reside either on a plane perpendicular to the lens axis or on different planes.

16. The actuator according to claim 9, wherein connection section(s), the area where the spring makes physical contact with the housing, of any of the one or more leaf springs of the first spring system (and/or the second spring system) reside either on a plane perpendicular to the lens axis or on different planes.

17. The actuator according to claim 9, wherein any of the first spring system and the second spring system is made of a plastic sheet, a metal sheet, a thin-film material, a thick-film material, a ceramic sheet, a polymer material, or a composite material comprising a plurality of elastic materials or flexible printed circuit board.

18. The actuator according to claim 9, wherein the first spring system or the second spring system further comprises one or more additional planar spring systems, whereby the planar spring system and the one or more additional planar spring systems altogether are regarded as constituting planar spring systems.

19. The actuator of claim 18, wherein all the constituting planar spring systems are substantially parallel to each others and substantially perpendicular to the direction of the lens axis.

20. (canceled)

21. The actuator according to claim 9, wherein the second spring system is formed by one or more springs other than the one or more leaf springs.

22. The actuator of claim 17, wherein the first or the second spring system is used as an electrode or an electrical connection component to conduct electric current or voltage to the coil or to the actuator.

23. The actuator according to claim 9, wherein at least one of the actuating members is a piezoelectric actuator or an energy convertor.
